(19) United States
(12) Patent Application Publication
(10) Pub. No.: US 2010/0162776 A1
(43) Pub. Date: Jul. 1, 2010

(54) LOCKING DEVICE WITH FIELD-CONTROLLABLE FLUID

(75) Inventors: Holger Böse, Wurzburg (DE); Thomas Gerlach, Schweinfurt (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Fraunhofer-Gesellschaft zur Forderung der angewandten Forschung e.v., Munchen (DE)

(21) Appl. No.: 12/595,652

(22) PCT Filed: Apr. 11, 2008
(86) PCT No.: PCT/EP2008/002900

§ 371 Date: Feb. 24, 2010

(30) Foreign Application Priority Data
Apr. 13, 2007 (DE) 10 2007 017 588.6

(51) Int. Cl. E05B 47/00; E05B 65/00

(52) U.S. Cl. 70/89; 70/278.7

(57) ABSTRACT

The present invention discloses a locking device having a control unit with
a first control element with a first surface (O1) and a second control element with a second surface (O2), the two control elements being moveable relative to each other with their two surfaces,
a spatial region (intermediate space Z) which is filled at least partially with a magnetorheological and/or electrorheological material (M) and is disposed between the first and the second surface, and
a field producer (4) with which a magnetic and/or electrical field can be produced in at least a partial region of the material-filled part of the intermediate space,
   a locking unit with a piston unit (2) and a locking system (3) with which the piston unit can be locked, the two control elements being able to be coupled to each other by the field produced in the intermediate space and the locking state of locking system and piston unit being able to be changed by means of this coupling.

The present invention relates to a locking device or a valve, a door lock device or a control lever containing such a locking device, respectively with a field-controllable fluid (magnetorheological and/or electrorheological fluid). Furthermore, the invention relates to a locking method in which such a locking device is used and also to the use of such a locking device.

Magnetorheological fluids (MRF) are suspensions of magnetically polarisable particles in a carrier fluid, the viscosity and other rheological properties of which can be changed rapidly and reversibly in a magnetic field. Analogously thereto, electrorheological fluids (ERF) are suspensions of electrically polarisable particles in a non-conductive carrier fluid, the rheological properties of which can be changed rapidly and reversibly in an electrical field. Both classes of fluids (subsequently also: field-controllable fluids) hence offer an ideal basis for locking devices, the locking state of which is controlled by the magnetic field or the electrical field.

Magnetorheological fluids, as can be used in the present invention, are described in the German patent specification DE 10 2004 041 650 B4 which is herewith introduced in its entire scope as a component of the present application.

It is the object of the present invention to make available a locking device (and a corresponding locking method) with which a field-controllable locking can be produced in a mechanically simple, reliable manner.

This object is achieved by a locking device according to claim 1, a locking device according to claim 14 and also a locking method according to claim 41. Advantageous embodiments of the locking device according to the invention are revealed in the respectively dependent patent claims. Uses according to the invention are revealed in claims 38 to 40 and also 42.

Subsequently, the subsequent invention is now firstly described in general, individual embodiments then following this general description. Individual features according to the invention, as are described subsequently, can hereby occur not only in combinations as shown in the special advantageous embodiments but they can also be configured or used within the scope of the present invention in any other combinations.

The basis of the solution according to the invention is the fundamental construction of a locking device comprising two units, a control unit and a locking unit, the latter subsequently termed alternatively also operating unit. On the basis of this separation into the two mentioned units, a field-controllable fluid (e.g. MRF) is then used in the control unit. The use can hereby take place in squeezing mode, in shear mode or in flow mode. The locking unit can be operated optionally hydraulically (using a non-field-controllable, hydraulic fluid which is prevented from flowing through a throughflow opening) or mechanically (the non-field-controllable, hydraulic fluid is replaced here by a mechanical element).

According to the invention, as also described subsequently in more detail, a piston unit and also a locking system (alternatively also termed locking unit or locking part) is provided.

The locking system can hereby be formed from an element, e.g. a locking pin, but it can also comprise a plurality of elements. There is understood by piston unit in the following a mechanical unit (possibly comprising a plurality of elements) of any shape, which is disposed advantageously at least partially within a housing. The piston unit need not therefore have a rotationally symmetrical configuration but can also be configured for example in a cuboid shape.

The locking device has two fundamental states: the locked state and the unlocked state. These two states of the locking device or of the locking system and the piston unit can be converted one into the other in that the relative position of the piston unit to the locking system is changed or in that these two units are moved relative to each other. The state “locked” is used here in a general context: locked can for example mean that the locking system locks the piston unit, i.e. restricts or prevents movement thereof within a surrounding housing. Likewise, “locked” can however mean that the locking system closes a throughflow opening configured in the piston unit. Equally, the state “unlocked” is understood in general: for example the relative moveablity of the piston unit in a housing (or also with respect to the locking system) can be permitted here. Likewise, there is hereby understood however for example the state in which the above-mentioned throughflow opening is opened within the piston unit, i.e. not closed by the locking unit.

In a particularly advantageous solution according to the invention, two surfaces are provided in the control unit which can be moved relative to each other (either moved laterally one past the other or towards or away from each other) so that the field-controllable fluid is sheared and/or squeezed in an intermediate space between these two surfaces in the control unit. A magnetic field or an electrical field is hereby produced in this intermediate space by a field producer (magnet or electrodes), as a result of which the field strength in the field-controllable fluid can be changed in this intermediate space. In the case of using a magnetorheological fluid and a magnet (electromagnet), the intermediate space filled with the MRF is hence situated in the magnetic circuit system of the locking device. The same applies in the case of using electrodes, an electrical field and an electrorheological fluid. As is described subsequently in even more detail, a corresponding change in the mechanical coupling of two control elements of the control unit can be effected by changing the magnetic or electrical field strength, said control elements having the above-described surfaces. As a result, as described subsequently even more precisely, a relative movement (for example between a piston unit and a closing part or a closing unit or also between a closing unit and a housing element) can be controlled in the locking unit, as a result of which a throughflow opening, which connects two chambers within one housing which are separated by a piston unit (subsequently also: piston), can be closed. As a result of such a closure, the flow of a non-field-controllable fluid between the two chambers within the housing can be prevented, as a result of which the movement of the piston unit within the housing can be correspondingly prevented.

However, it is likewise possible, in a particularly advantageous solution according to the invention, to restrict or entirely to prevent the throughflow of a field-controllable fluid through a gap or a throughflow opening between the control unit and the locking unit by applying an external magnetic or electrical field in order to build up a pressure and hence to initiate locking. This embodiment variant is also described subsequently even more precisely.

The locking device according to the invention, relative to locking devices known from the state of the art, has a series of significant advantages:

One particular advantage of the present invention resides quite generally in the separation into a control- and into an operating or locking unit. The essential advantage of this hybrid operating principle, relative to a purely magnetorheological or electrorheological locking, resides in the virtually unlimited locking force which can be achieved in this way. As a result, the relatively heavy unit containing the MRF or the ERF need not in particular be designed to be so large, which involves a lower energy requirement.

A simple, mechanically non-complex system is achieved by the locking device according to the invention.

When using two mutually moveable surfaces, these two surfaces can be securely coupled to each other mechanically in a simple manner by means of the fluids (MRF or ERF) stiffened in the magnetic field or in the electrical field. As a result, locking or the solution of locking is possible in a simple and reliable manner in the locking device.

When using the field-controllable fluid, in particular the magnetorheological fluid MRF, in the squeezing or shearing operation, significantly lesser demands are made upon the properties of the field-controllable fluid and a significantly more reliable operation of the locking device is possible. For example, in the basic state, an MRF without a magnetic field can be very viscous, even magnetorheological gels for example which are not intrinsically free-flowing can be used instead of an MRF. Hence problems which occur in the MRF because of sedimentation of the magnetic particles are avoided. The same applies for electrorheological fluids.

The advantage of the variant in the flow mode resides in the fact that no parts which are moveable relative to each other and require to be guided at a defined spacing relative to each other need be used.

Fields of application of the locking device according to the invention are in particular mechanical and/or electrical locks (e.g. electrical contact) or locking mechanisms or temporary fixings. Possible applications of the locking device according to the invention are in particular electrically controllable locking of moveable parts which are to be fixed temporarily. Examples of this are doors, windows, shutters or operating elements, such as e.g. control levers, push buttons or knobs which are to be made safe against faulty operation.

The present invention hence describes a locking device which can be divided essentially into two units, a control unit and a locking unit. In the control unit which contains the magnetorheological or the electrorheological fluid, advantageously two mutually moveable surfaces, between which the MRF or the electrorheological fluid is situated in the intermediate space, are advantageously coupled securely to each other mechanically by applying a magnetic or electrical field (which then covers the intermediate space). With sufficiently high field strength, the two surfaces can no longer be moved relative to each other. After switching off the field, both surfaces can again be moved relative to each other entirely without a field-produced resistance, a shear movement and/or a squeezing movement being effected with respect to the magnetorheological or electrorheological fluid.

In the second unit, the locking unit which contains a non-field-controllable fluid (or also a gas), a piston unit or a piston is locked by the above-described coupling.

Advantageously, the locking unit or the operating unit has a piston with a throughflow opening, a locking system (closing part) and also a non-field-controllable fluid. However the locking system can also be provided alternatively as part of the control unit. During the movement of the piston, advantageously the non-field-controllable fluid is transported through a throughflow opening between two chambers which are separated from each other by the piston as long as the throughflow opening is not closed by the locking system. Advantageously, the movement of the piston is locked by closing the opening.

Advantageously, as described subsequently in even more detail, the locking system and a switch element (with which the piston unit can be moved, in particular a switch rod) are hereby connected mechanically rigidly to the two surfaces in the control unit, between which surfaces the magnetorheological or the electrorheological fluid is situated. However it is also possible that merely the switch element is connected mechanically rigidly to one of the two surfaces in the control unit.

Advantageously, the two mutually moveable surfaces of the control unit or the corresponding control elements are formed by two cylinder elements (tubes) which are inserted one in the other concentrically or by two plane-parallel plates which are disposed parallel to each other and can be mutually displaced laterally or can be moved towards each other and away from each other. The piston unit can be configured advantageously such that the piston performs a linear movement in the locking unit. The magnetic or electrical field hereby extends advantageously perpendicular to the two surfaces of the control elements and penetrates the gap between the surfaces or the intermediate space. If a magnetorheological fluid is used, then the mutually moveable surfaces are situated advantageously in a magnetic circuit with a coil, the current flowing in the foil producing the magnetic field. In the case an electrorheological fluid, the two mutually moveable surfaces advantageously also form the electrodes between which the electrical field is configured. As a result of the magnetic or electrical field, the mutually moveable surfaces are connected securely to each other frictionally via the stiffened magnetorheological or electrorheological fluid (frictional connection) so that, with sufficiently high field strength, the moveability of the two surfaces relative to each other is removed. If a sufficiently strong field is applied, stiffening of the field-controllable fluid and a secure coupling of the two control elements or surfaces is hence effected, i.e. the above-described locking.

Another advantageous possibility resides in restricting or preventing the throughflow of a magnetorheological or an electrorheological fluid through a throughflow opening by means of the magnetic or electrical field and hence building up a pressure which initiates the locking.

In an advantageous embodiment variant, the locking device hence comprises a control unit which contains a magnetorheological or electrorheological material and also a locking unit (locking unit) which contains mutually moveable parts and also a non-field-controllable fluid and/or mechanical locking elements. The control unit hereby has at least two mutually moveable surfaces, between which the magnetorheological or electrorheological material can be subjected to a shear movement and/or a squeezing movement, or a gap (throughflow opening) through which the magnetorheological or electrorheological material can be pressed through. The control unit hereby contains the magnetic field production (or the production for the electrical field) which stiffens the field-controllable material between the surfaces or in the mentioned gap. The locking unit contains either a closing piston which separates two chambers from each other which are filled with a non-field-controllable fluid and are connected to each other by a valve which is formed from at least two mutually moveable parts and is hence closeable, or the locking unit contains one or more locking elements, as a result of which the movement at least of one moveable part is locked. The locking device can hereby be configured such that the piston in the locking unit performs a linear movement or such that it performs a rotary movement (see subsequent paragraph). Advantageously, the mutually moveable parts, in particular those in the locking unit (closing piston or locking elements), can be retained in an equilibrium position by at least one spring element.

However, in another advantageous embodiment, it is also possible to construct the locking device according to the invention on the basis of a rotary piston unit instead of on the basis of a linear piston unit. A movement of the rotary piston is then locked. Likewise a control- and a locking unit are produced hereby in the locking device. As in the case of the linear locker, the movement of the rotary piston is correspondingly prevented in the locking unit by preventing the throughflow of the non-field-controllable fluid which is displaced by the rotary piston through a gap (throughflow opening or valve gap). The closure of the throughflow opening hence locks the device. At least one of the mutually moveable parts forming the throughflow opening is advantageously connected mechanically rigidly to one of the mutually moveable surfaces in the control unit. The two surfaces in the control unit, between which the magnetorheological or electrorheological fluid is situated in an intermediate space, are integrated just as with the linear locker in a magnetic circuit or serve as electrodes for producing the electrical field. Therefore both the locking of a translatory movement and the locking of a rotational movement is possible according to the invention.

A further possibility resides in those moveable parts which ultimately change or control the locking state of locking system and piston unit in the locking unit, in the control unit or between the locking unit and control unit, being retained in an equilibrium position relative to each other, connected amongst each other or to each other by at least one spring element. Hence a pre-adjustment of the locking state is predetermined without applying a field.

In a further advantageous embodiment variant, it is possible to provide at least one permanent magnet in addition to an electromagnet in the magnetic circuit of the control unit and/or between control- and locking unit. As a result of such integration of an additional permanent magnet which likewise affects the magnetic field for the magnetorheological fluid in the intermediate space or in the throughflow opening, a locking state of the device can be produced without energy expenditure (adjustment of the operating point of the locking device; mechanical coupling of the two surfaces without current flow in the coil of the electromagnet is possible).

Further advantageous embodiment variants reside in the fact that, instead of an MRF, there is used as field-controllable material a magnetorheological gel (MRG), a magnetorheological elastomer (MRE) or a magnetorheological foam (MRS) or a combination of such materials. An MRG is hereby a material which is in fact soft in contrast to an MRF but is not fluid. Analogously to MRF, it can be deformed irreversibly in any manner and can be stiffened in the magnetic field analogously to an MRF. An MRE is a cross-linked material which therefore has a prescribed shape from which it can be deformed reversibly only in a limited manner. An MRS is an elastomer foam, the pores of which are filled with an MRF. Like the MRE, an MRS also has a prescribed shape from which it can be deformed reversibly only in a limited manner. In the case of MRE or MRS, a restoring force can be produced between the mutually moveable surfaces at the same time due to the elasticity of the material, which restores said surfaces back into their respective starting position after switching off the magnetic field.

In a further advantageous embodiment variant, there can be used as field-controllable material, instead of an electrorheological fluid (ERF), an electrorheological gel (ERG), an electrorheological elastomer (ERE) or an electrorheological foam (ERS). These materials are defined entirely analogously to the corresponding magnetorheological materials or have the properties of the corresponding magnetorheological materials.

A particularly advantageous selection of the non-field-controllable fluid resides in using the same fluid which is also used as carrier fluid in the magnetorheological or electrorheological fluid also as non-field-controllable fluid.

Instead of using a non-field-controllable fluid, a gas can also be used.

The subsequent invention is described subsequently with reference to individual embodiments. In the individual Figures which are associated with the embodiments, the same or corresponding elements of the damping device are hereby designated with identical reference numbers.

There are shown:

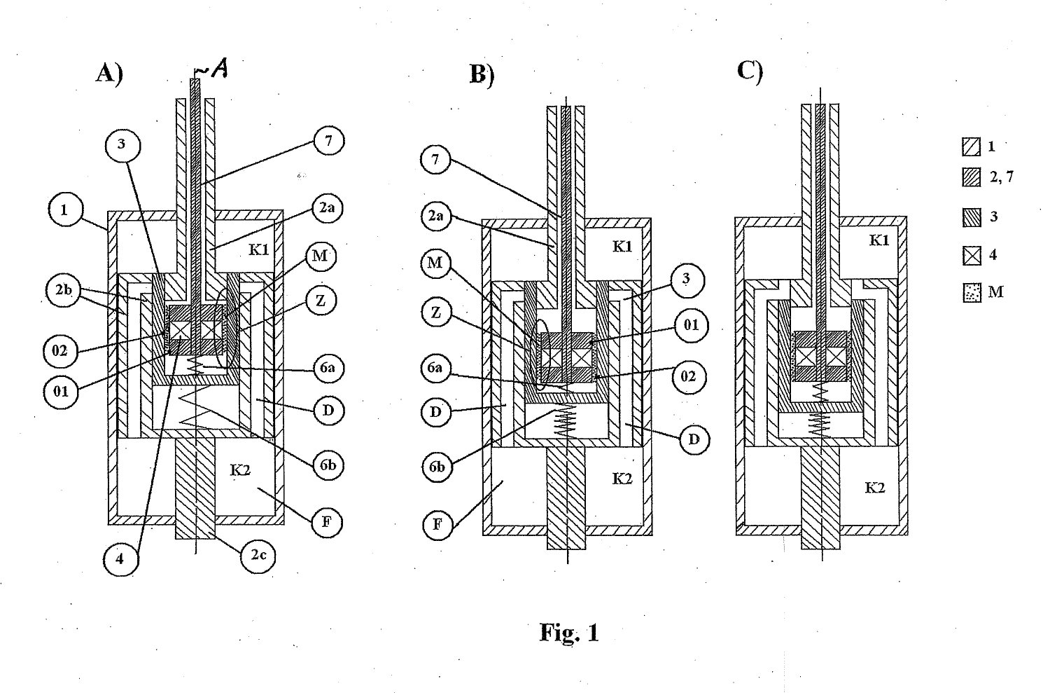

FIG. 1 a locking device according to the invention which is configured as linear locker (hydraulic locking).

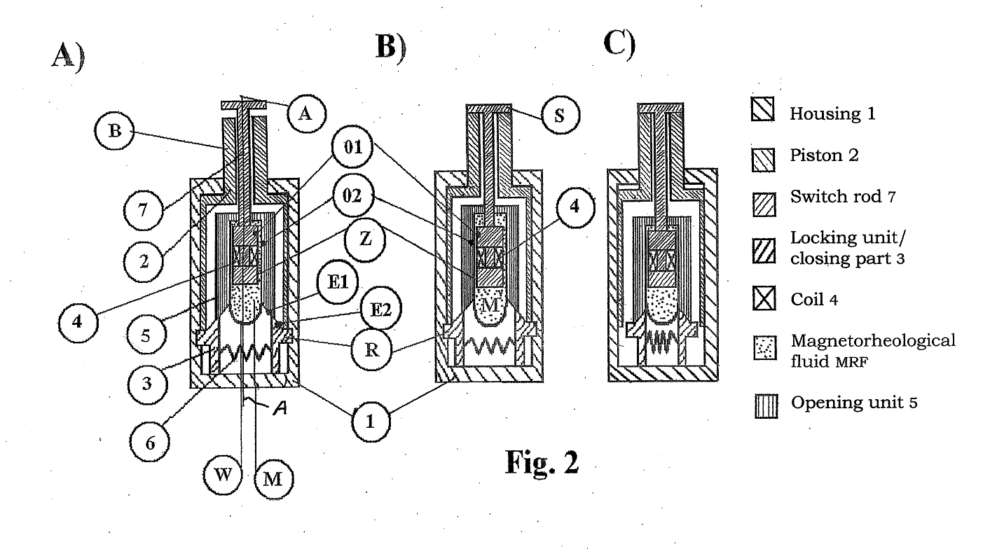

FIG. 2 a second linear locking device according to the invention (mechanical locking).

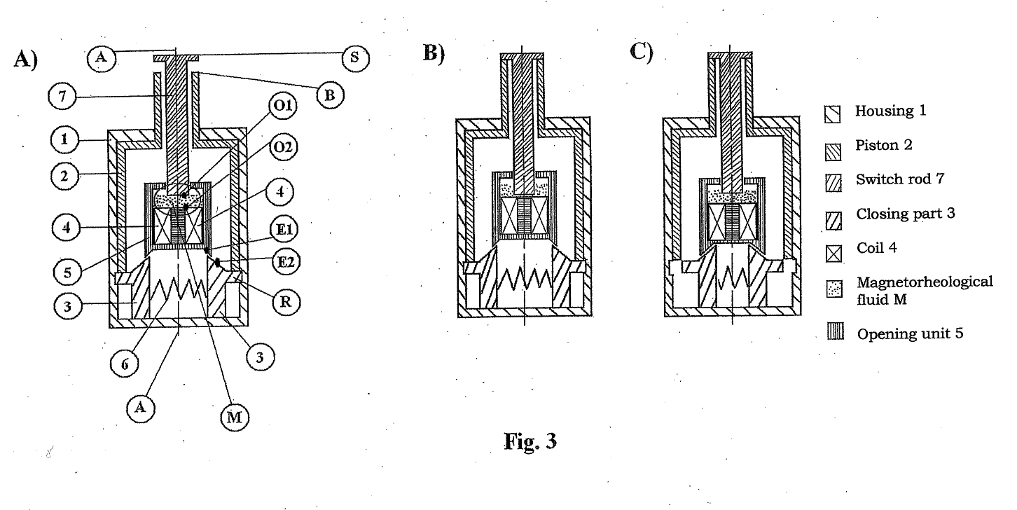

FIG. 3 a third linear locking device according to the invention (mechanical locking).

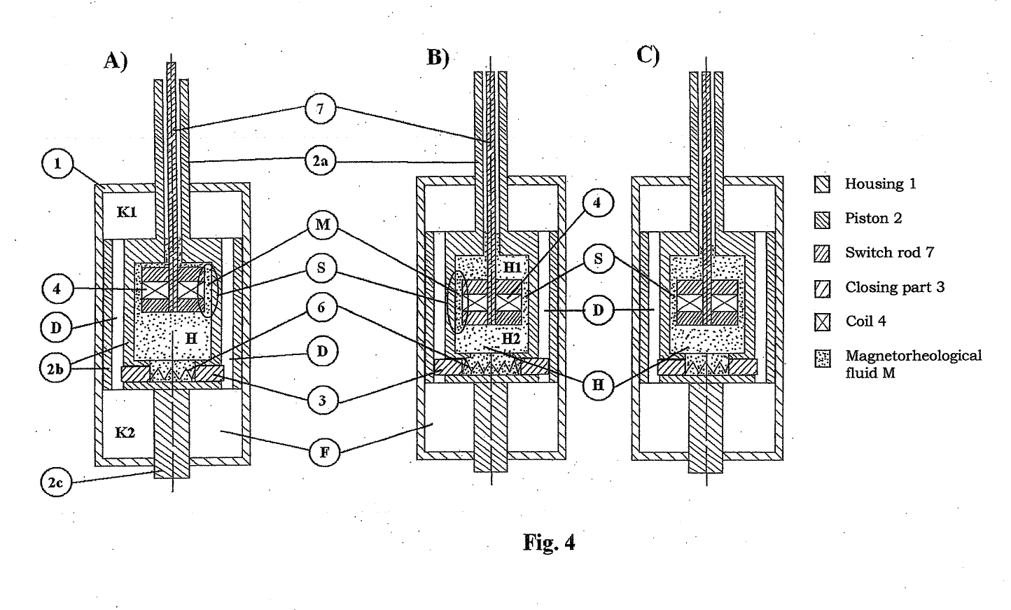

FIG. 4 a fourth linear locking device according to the invention (hydraulic locking).

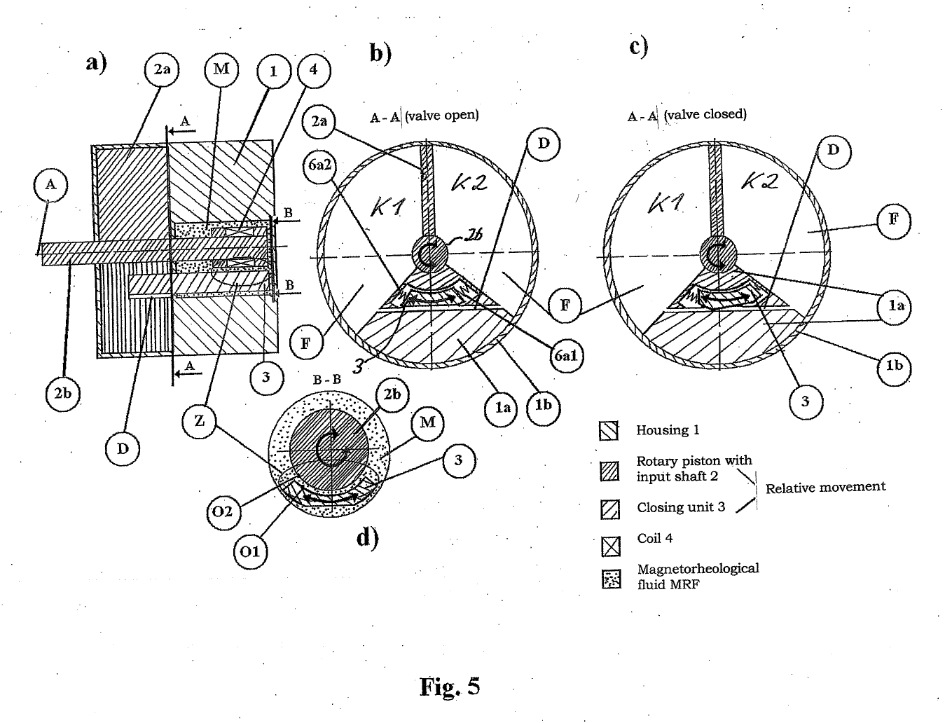

FIG. 5 a rotary locking device according to the invention (hydraulic locking).

FIG. 1 shows a locking device according to the invention which is constructed as a hydraulic linear locker (=locking of a translatory movement). The locking device comprises a housing 1. A piston unit 2 is disposed in this housing 1. The piston unit 2 is moveable within the housing 1 along an axis of symmetry A of the housing 1, i.e. relative to the housing 1. Housing 1 and piston unit 2 hereby form cylinder units which are disposed one in the other concentrically. The switch rod 7 is inserted concentrically into the piston unit 2. Said switch rod 7 is also displaceable along the axis A relative to the piston unit 2 and relative to the housing 1. FIG. 1 shows a section through the central axis of symmetry A in the longitudinal direction of this unit. The device is hence rotationally symmetrical about this axis A. The piston unit comprises an upper piston element 2a which protrudes through the upper cover surface of the housing 1 into the housing, a central piston element 2b (actual piston) connected to the latter and a lower piston element 2c which is connected to this element 2b and protrudes through the lower cover surface of the housing 1 into the housing 1. Two chambers K1 and K2 are separated by the actual piston 2b within the housing 1 and have a constant total volume, their individual volumes changing however by displacing the piston 2 within the housing 1. The piston unit 2b has a throughflow opening D which connects the two chambers K1 and K2 to each other. Upon displacing the piston 2 within the housing 1, a non-field-controllable fluid F hence flows, according to the direction of movement, from the chamber K1 into the chamber K2 or vice versa.

The locking unit 3 is disposed concentrically within the actual piston 2b, within which, again concentrically, the lower portion of the switch rod 7 to which the coil 4 of the electromagnet is securely connected mechanically is disposed. The closing unit 3 is displaceable along the axis A relative to the piston 2b and to the housing 1 so that, according to the position of the locking unit 3, the throughflow opening D is either closed or opened relative to the actual piston 2b.

Between the inner wall of the closing unit 3 and the lower portion of the switch rod 7, the magnetorheological fluid M is disposed in the intermediate space Z. The outer circumference of the lower portion of the switch rod 7 with the coil 4 of the electromagnet forms the first surface O1 of the first control element. The inner wall of the locking system 3 situated opposite this outer circumference forms the second surface O2 of the second control element. The lower portion of the switch rod 7 is connected via a restoring spring 6a to the inner wall of the base portion of the locking system 3. The outer wall (orientated towards the element 2c) of the base portion of the locking system 3 is connected by a closing spring 6b to the upper portion of the lower piston rod unit 2c.

The illustrated locking device is configured as a valve. Locking is effected hereby in the form of a mechanical closing of the throughflow opening D of the piston unit 2b by the closing element 3. The mode of operation of the device is now described in the following, FIG. 1A showing the closed state of the valve (starting state: before switch rod 7 is moved downwards), FIG. 1B showing the locked state (without an applied magnetic field) and FIG. 1C the unlocked state (with applied magnetic field) of the valve.

Firstly, the locking device is completely closed by the locking system 3 (closure of channel D). If the locking device is to be unlocked (opening of channel D), then the closing unit 3 must be moved relative to the piston 2b (downwards). This takes place with the switch rod 7 which is moveable relative to the piston 2: if no magnetic field is acting on the MRF M in the intermediate space Z, then the closing part 3 (see FIG. 1B) remains, despite movement of the switch rod 7, in its position, as shown in FIG. 1A, and the valve remains closed (no throughflow of the non-field-controllable fluid F between the chambers K1 and K2 is possible, hence no movement of the piston unit 2 relative to the housing 1 can take place either). If now however, a sufficiently strong magnetic field is produced by means of the coil 4 in the intermediate space Z, then the MRF stiffens in this intermediate space Z, as a result of which the switch rod 7 is securely coupled mechanically (frictionally) to the locking system 3. By movement of the switch rod 7 downwards, the closing unit 3 is likewise moved downwards, as a result of which the throughflow opening D is opened (coupling of the closing part 3 to the switch rod 7). Hence the valve is opened in this way (FIG. 1C).

The closing spring 6b is provided here as compression spring which ensures, in the relaxed state, that the closing element 3 closes the throughflow opening D. The closing element 3 must hence be moved by means of the switch rod 7, as described above, in opposition to this spring force in order to open the valve. In the inoperative state (without field), the restoring spring 6a ensures that the switch rod 7 adopts the position shown in FIG. 1A within the piston 2 (pushed upwards as far as possible within the piston).

In the presented example, there are associated with the control unit the restoring spring 6a, the closing element 3, the switch rod 7 and also the electromagnet or the coil 4. There are associated with the locking unit the piston unit 2, the housing 1 and also the closing spring 6b.

This embodiment hence shows a locking device with magnetorheological fluid with a shear movement in the intermediate space Z, the first surface O1 being configured as part of the switch rod 7 and of the coil 4 and the second surface O2 as part of the locking system 3.

FIG. 2 shows a further now mechanical linear locking device according to the invention which, apart from the subsequently described differences, is constructed or used corresponding to the device shown in FIG. 1.

FIG. 2A and FIG. 2B hereby show the locked state of the locking device. FIG. 2C shows the unlocked state of the locking device. The device is again constructed cylinder-symmetrically about the axis of symmetry A. This concerns a mechanical locking mechanism which is controlled by a magnetorheological fluid M.

Within the housing 1, the following elements of the locking device are disposed, inserted respectively one in the other concentrically (and observed from outside towards the inside to the axis A): firstly the piston 2, then the opening unit 5 inserted concentrically in the latter and at a spacing therefrom. The upper portion of the switch rod 7 is inserted concentrically into the upper portion of the piston 2; the lower, thickened portion of the switch rod 7 (on which the coil 4 is mounted) is inserted concentrically into the opening unit 5. All these above-mentioned elements 1, 2, 5 and 7 (with 4) are moveable relative to each other, as long as no fixing is effected, along the axis A.

The outer circumference of the lower portion of the switch rod 7 (with the coil 4) forms the first surface O1 of the first control element. The inner wall surface of the opening unit 5 which is situated opposite this outer circumference forms the second surface O2 of the second control element. The magnetorheological fluid M is disposed in the intermediate space Z between the two surfaces O1 and O2. The opening unit 5 here represents a hollow cylinder which is sealed at the bottom by the wall element W and also by the chamfered surface E1, described subsequently in more detail, and which is sealed at the top by the fluid-tight leadthrough of the switch rod 7 through the upper cover surface (of the opening unit 5). Leakage of the magnetorheological fluid M is prevented in this way.

Within the housing 1 and below the units 2, 7 (with 4) and 5, the locking system 3 is disposed. This comprises two approximately semicircular cylindrical hollow wall elements which are pressed laterally by a spacing spring 6 in the inoperative state against the inner wall surfaces of the housing 1. Since the lower portion of the piston 2 stands in this position directly on a ring R which is disposed on the outer circumference of the locking system 3 (said ring itself being part of the unit 3), no movement of the piston 2 within the housing is possible 1 in this state (locked state), as shown in FIG. 2A.

The lower portion of the opening unit 5 now has, on the outer circumference, with respect to the axis A and with respect to a plane perpendicular to the axis A, a lower end surface E1 which is at an angle greater than 0° and less than 90° (preferably: respectively 45°) and is therefore chamfered. Likewise, the upper portion of the locking system has, on the outer circumference, chamfered upper end surfaces E2. The end surfaces E1 and E2 extend parallel to each other and engage laterally offset one in the other since the surface A1, observed radially, has a somewhat smaller spacing from the axis A.

The mode of operation of the illustrated locking device is now as follows: if the switch rod 7 is pushed mechanically downwards, two different states are possible: when current is switched off in the coil 4 (FIG. 2B), the switch rod moves firstly freely downwards until the protruding part S strikes by its upper portion on the upper delimitation surface B of the piston 2. The piston 2 cannot now be moved downwards because of the blockage (above-described upright stance) of its lower portion on the ring R of the closing unit 3 (locking of the device).

If now however current is switched on in the coil 4, then the MRF M in the intermediate space Z stiffens: as a result of this stiffening, the opening unit 5 is coupled securely to the switch rod 7 so that, upon moving the rod 7 downwards, now the opening unit 5 (which has not moved relative to the housing when the field is switched off) is also jointly moved downwards. Due to the meshing of the lower portion of the opening unit 5 with the upper portion of the closing unit 3 (engagement of both parallel surfaces E1 and E2 one in the other), the two semicircular parts of the locking system 3 are pressed inwards (i.e. towards the central axis A) in opposition to the tensioning force of the compression spring 6 by the downwards movement of the opening unit 5. Hence, because of the movement of the contact ring R inwards towards the axis A, the locking device 3 frees the movement of the piston 2 downwards (on the right, FIG. 2C). The locking is hence removed only when current flows in the coil 4.

Here also, the magnetorheological fluid M is used according to the invention in shear mode.

There are associated with the control unit, in the illustrated case, the opening unit 5, the switch rod 7 and also the coil 4 connected securely to this unit 7. There are associated with the operating unit (locking unit) the piston 2, the housing 1, the closing element 3 and also the spacer (spring) 6 which, in the case shown in FIG. 2A (inoperative state), presses the two partial elements of the closing unit 3 radially outwards.

FIG. 3 shows a further mechanical linear locking device according to the invention. This is basically constructed similarly to the device shown in FIG. 2 (this relates in particular to the elements 1, 2, 3 and 6), the differences are now described subsequently.

In the interior of the opening unit 5 (the lower outer portion of which is constructed as in FIG. 2 and hence engages, corresponding to the chamfered surface E1, in the chamfered surface E2 of the closing unit 3) a cavity is configured. Into the latter, the switch rod 7 protrudes through the upper cover surface of the opening unit 5. In the upper portion of this cavity into which the switch rod 7 protrudes, the intermediate space Z which is filled with the magnetorheological fluid M is configured. In the lower portion of the cavity, the coil 4 of the electromagnet is disposed concentrically about the axis A. The upper surface of the coil 4 together with the upper surface of the coil core forms the second surface O2 of the second control element within the cavity. The lower base surface of the switch rod 7 forms the first surface O1 of the first switch element. In the inoperative state shown in FIG. 3, the unit 5 stands on the unit 3 because of its weight without however overcoming the spring force (see subsequently) of the spring 6.

The illustrated device now functions corresponding to the principle presented in FIG. 2; the MRF M is used here however in squeeze mode (FIG. 3A shows the starting state before the switch element 7 is moved downwards, FIG. 3B the locked state without field and FIG. 3C the unlocked state with magnetic field). As long as no magnetic field is acting on the fluid M, the MRF can be displaced radially outwards by a movement of the switch rod 7 downwards out of the intermediate space Z (between the two squeezing surfaces O1 and O2) in the cavity within the opening unit 5. Hence the opening unit 5 and the closing unit 3 remain in their position (therefore do not move relative to the housing 1). As a result, the piston 2 remains locked by the contact surface R of the closing unit 3. The piston hence cannot move without a magnetic field. If now however a magnetic field is applied by a current flow in the coil 4, the MRF in the intermediate space Z can be displaced radially outwards only with difficulty or no longer within the cavity in the opening unit 5. Hence a force is exerted downwards on the opening unit 5. By means of this force, the opening unit 5 is moved downwards and, due to the sliding of the surfaces E1 and E2 one into the other, opens the closing element 3 in that the components thereof are moved inwards to the axis A in opposition to the spring force of the spring 6. In this way, when the locking of the pistons 2 is removed within the housing 1 (and relative to the latter), the piston 2 can be moved downwards.

There are associated with the control unit in the present case the opening unit 5, the switch rod 7 and also the coil or the electromagnet 4. There are associated with the locking unit the piston 2, the housing 1, the closing element 3 and also the spring element 6.

FIG. 4 shows a further, now again hydraulic, linear locking device according to the invention. This device is also constructed corresponding to the device shown in FIG. 1 so that only the differences from this device are described subsequently (FIG. 4A shows the starting state before movement of the switch rod 7 downwards (opened state), FIG. 4B the locked state (with field) and FIG. 4C the unlocked state (without magnetic field)).

The actual piston 2b, radially at a spacing from the central axis A has from inside to outside firstly a cavity H, then a throughflow opening D between the two chambers K1 and K2. In the upper region of the cavity H, the switch rod 7 is disposed inserted concentrically within the actual piston 2b (and also with its upper portion also within the upper piston rod element 2a). The lower portion of the switch rod 7 is hereby thickened relative to the upper portion and carries the coil 4 of the electromagnet. The cavity H is filled with the magnetorheological fluid M. Between the outer circumference of the thickened portion of the lower switch rod part and that inner wall of the actual piston 2a which delimits the cavity H to the outside (observed from the axis A), a throughflow opening S is configured. In alternative variants, the opening S can however also be configured within one of these elements (switch rod 7 or piston 2). These and also the thickened lower end of the switch rod 7 (including coil 4) divide the cavity H into two chambers H1 and H2 (with a constant total volume). By means of a movement of the switch rod 7 relative to the piston 2b along the axis A, the chamber volumes H1 and H2 can be changed (with a constant total volume), the magnetorheological fluid being displaced between these two chamber parts (through the gap S).

In the lower portion of the piston 2b, the closing element 3 of the control unit is disposed in the cavity H. This comprises here two flat, semicircular hollow cylindrical portions which are retained via a tension-compression spring 6 in an equilibrium position in which the throughflow opening D is opened. If the two parts of the closing unit 3 (observed from the axis A) are moved radially outwards in opposition to the spring force of the spring 6, then the throughflow opening D is closed by this movement.

The mode of operation is hereby as follows: with this principle, the magnetorheological fluid is used in flow mode. In the basic sate (equilibrium position of the closing unit 3), the valve of the locking unit is open, as shown in FIG. 4A. The switch rod 7 and the coil 4 mounted securely thereon form a control valve of the control unit. If the switch rod 7 is moved along the axis A when the magnetic field is switched off, then this switch rod can be moved relatively easily through the MRF in the cavity H. The valve of the locking unit or the locking unit hereby remains open (flowing of the MRF from the chamber H1 into the chamber H2 or vice versa). If now a sufficiently large current flows through the coil 4, then a magnetic field is consequently produced in the throughflow opening S and the MRF is stiffened in this throughflow opening S (restriction of the throughflow of the MRF through the control valve). As a result, with movement of the switch rod 7 downwards in the lower chamber H2 of the control unit, a pressure is built up. This pressure has the effect that the two parts of the closing unit 3 are pressed radially outwards so that the throughflow opening D is closed. Hence the valve of the locking unit is closed by the closing parts 3. A movement of the piston unit 2 relative to the housing 1 is then no longer possible (locking of the device, see FIG. 4B). Without a magnetic field, the locking is initiated again by reducing the pressure or by corresponding equalisation flows between the chambers H1 and H2 (FIG. 1C).

In the illustrated case, there are associated with the control unit the closing parts of the closing unit 3, the switch rod 7 together with the coil 4 and also the restoring spring 6. There are associated with the locking unit the piston unit 2 and also the housing 1.

FIG. 5 shows a further embodiment in the form of a hydraulic rotary vibration locking device, i.e. a device for locking a rotary movement. This device has in principle a similar mode of operation to for example the device described in FIG. 1; identical or corresponding device elements are therefore provided with identical reference numbers.

FIG. 4a hereby shows a section through a plane in which the central axis A (at the same time axis of rotation here) of the rotary piston unit 2 is situated. FIGS. 4b and 4c show a section perpendicular to this plane or to the axis of rotation A at the level A-A. FIG. 4d shows a corresponding section at the level B-B.

The rotary piston 2 is secured rigidly here on the input shaft of the axis of rotation A and has a shaft portion 2b which is disposed rotationally symmetrically about the axis A and also a wing element 2a which protrudes therefrom radially symmetrically. According to the position of the wing element (see FIGS. 4b and 4c), chamber volumes of different sizes of the two chambers K1 and K2 are produced in the housing 1. The cylindrical housing 1 hereby has a separating element 1a (represented approximately triangularly in FIGS. 4b and 4c) which separates the two chambers K1 and K2 from each other. This element is disposed along a part of the housing outer circumference and extends from the inner wall surface of the housing outer circumference 1b inwardly up to the axis A. Furthermore, it extends, viewed along the axis A, in a seal up to the input shaft portion 2b. The throughflow opening D is configured as valve gap in the separating element 1a. By moving the wing portion 2a along the outer circumference of the housing 1 and within the housing interior, the non-magnetorheological and non-electrorheological fluid F is hence moved to and fro by being pressed through the valve gap D between the two chambers K1 and K2 (change in chamber volumes). Within the separating element 1a, the closing unit 3 is mounted approximately concentrically about the axis of rotation A and at a spacing from the latter. The form of this mounting or of the closing unit 3 corresponds approximately to the partial portion (sector) of a hollow cylinder. The closing unit 3 is hereby connected via two tension-compression springs 6a1 and 6a2 to the mounting in the separating element 1a such that it is rotatable about the axis A over a small angle portion (angle sector). This rotation makes it possible for the opening D to be closed (locking of the device) in one position of the unit 3 (FIG. 4c), and, in another position of the unit 3 (FIG. 4b), for the opening D to be passable. The closing unit 3 is hereby retained by the two springs 6a1 and 6a2 in an equilibrium position (in this, the valve is opened).

The first control element (or the first surface O1) is hereby configured as the inner wall portion of the closing unit 3 which is orientated towards the axis A. The second control element (or the second surface O2) is hereby configured as the outer wall portion of the input shaft element 2b which is orientated away from the axis A. As FIG. 4D shows, the intermediate space between these two control elements is filled with the magnetorheological fluid MRF or M. Furthermore, in the region of the intermediate space Z, the electromagnet 4 in the form of a toroid which is disposed rotationally symmetrically about the axis A and is connected securely to the input shaft element 2b is disposed.

With sufficient magnetic field strength in the intermediate space Z, a frictional, secure, mechanical coupling of closing unit 3 and input shaft portion 2b of the rotary piston unit 2 can hence be achieved. By suitable adjustment of the position of the rotary piston unit 2 relative to the housing, the restoring force of the springs 6a1 and 6a2 and also the field strength in the intermediate space Z, the relative position of the closing unit 3 relative to the ribbed portion of the housing 1 can hence be changed or adjusted. By influencing the arrangement of the closing unit 3 relative to the portion 1a of the housing 1, the relative movement of unit 2 and unit 1, according to the chosen field strength, hence has the effect of opening or closing the throughflow opening D of the valve gap between the two chambers K1 and K2. According to the position of the closing unit 3 relative to the housing 1, the rotary piston 2 within the housing 1 is hence blocked (locked) or released (unlocked).

In the illustrated example, the rotary piston 2a, 2b is hence mounted rigidly on the input shaft. Parallel thereto, the coil 4 for field production is mounted on the input shaft element 2b. By means of the rotary movement of the wing portion 2a in the locking unit, the non-field-controllable fluid F is pressed through the valve gap D when the field is switched off. The closing unit 3 can be moved relative to the housing 1 and to the input shaft or to the rotary piston 2. The closing element is retained by the two springs 6a1 and 6a2 in its starting position (equilibrium position). By moving the closing part portion 3 of the valve in its guide within the ribbed housing portion 1a, the valve gap D can be closed. Since the coil 4 is situated on the same shaft as the rotary piston, said coil is likewise moved during a rotary movement of the piston.

The relative movement of the closing element and housing 1 is caused by a magnetic field-dependent shearing (rotary shearing) of the MRF which is situated in the intermediate space Z between the two surfaces O1 and O2. If no magnetic field is acting in the intermediate space Z, the closing element 3 is moved by the springs 6 into its starting position or retained there, the gap D is open.

There are associated with the control unit in the present case the shaft portion 2b (including coil 4) and also the portion of the closing unit 3 in the region B-B (shown in FIG. 5a on the right next to the section line A-A; there are associated with the locking unit the wing portion 2a, the housing 1 and also the springs 6a1 and 6a2.

1. A locking device having
a control unit with
a first control element with a first surface (O1) and a second control element with a second surface (O2), the two control elements being moveable relative to each other with their two surfaces,
a spatial region (intermediate space Z) which is filled at least partially with a magnetorheological and/or electrorheological material (M) and is disposed between the first and the second surface, and
a field producer (4) with which a magnetic and/or electrical field can be produced in at least a partial region of the material-filled part of the intermediate space,
a locking unit with a piston unit (2) and
a locking system (3) with which the piston unit can be locked,
the two control elements being able to be coupled to each other by the field produced in the intermediate space and the coupling state of locking system and piston unit being able to be changed by means of this coupling,
wherein
the control unit has an opening unit (5) which can be moved relative to the piston unit (2) and the locking system (3) and which can be coupled to the locking system (3) and/or to the piston unit (2), the locking state of locking system and piston unit, when the two control units are coupled to each other, being able to be changed by the further coupling of the opening unit to the locking system and/or to the piston unit.

2. A locking device having
a housing (1),
a control unit with
a first control element with a first surface (O1) and a second control element with a second surface (O2), the two control elements being moveable relative to each other with their two surfaces,
a spatial region (intermediate space Z) which is filled at least partially with a magnetorheological and/or electrorheological material (M) and is disposed between the first and the second surface, and
a field producer (4) with which a magnetic and/or electrical field can be produced in at least a partial region of the material-filled part of the intermediate space,
a locking unit with a piston unit (2) and
a locking system (3) with which the piston unit can be locked,
the two control elements being able to be coupled to each other by the field produced in the intermediate space and
the housing (1), the control unit and/or the locking unit being configured such that, after the two control units are coupled to each other, the locking system (3) can be moved relative to the piston unit (2) or relative to the housing (1) such that a throughflow opening (D) can be closed by means of this relative movement, which throughflow opening connects two chambers (K1, K2) within the housing which are separated by the piston unit (2), as a result of which by means of this coupling the locking state of locking system and piston unit can be changed.

3. The locking device according to claim 1, having
a housing (1).

4. The locking device according to claim 3, wherein
the housing is part of the locking unit
and/or the piston unit and/or the locking system is disposed at least partially within the housing.

5. The locking device according to claim 1, wherein
the locking device, when the two control elements are coupled to each other, can be converted from the locked state into the unlocked state,
or
the locking device, when the two control elements are coupled to each other, can be converted from the unlocked state into the locked state.

6. The locking device according to claim 1, wherein
the locking system and/or the piston unit are disposed and/or configured such that, when the two control elements are coupled to each other, the locking system can be moved relative to the piston unit and, as a result of this relative movement, the locking state of locking system and piston unit can be changed
and/or
the locking system and/or the piston unit are disposed and/or configured such that, when the two control elements are coupled to each other, at least a part of the control unit can be moved relative to the locking system and, as a result of this relative movement, the locking state of locking system and piston unit can be changed.

7. The locking device according to claim 1, wherein
the two control elements can be coupled to each other mechanically, in a form-fit and/or frictionally and/or can be fixed relative to each other.

8. The locking device according to claim 1, wherein
the locking system is configured as part of the control unit and in that the locking system is coupled to one of the two control elements, the coupling being a mechanical coupling and/or being effected via a rigid, mechanical connection and/or the one of the two control elements being configured as part of the locking system.

9. The locking device according to claim 1, wherein
the two control elements are disposed and/or configured such that the relative movement of the two surfaces to each other for the magnetorheological and/or electrorheological material in the intermediate space is configured as a shear movement and/or as squeezing movement.

10. The locking device according to claim 1, wherein
the control unit has a switch element (7).

11. The locking device according to claim 1, wherein
a locking system (3) which has first chamfered end faces (E2) and an opening unit (5) which has second chamfered end faces (E1), the first and the second end faces extending parallel to each other and engaging in each other laterally offset.

12. The locking device according to claim 1, which
includes a mechanical, frictional and/or form-fit further coupling.

13. The locking device according to claim 1,
wherein
the surfaces or control elements which are moveable relative to each other are configured as plane-parallel plates which, at a constant spacing from plate plane to plate plane, are mutually displaceable laterally or moveable towards each other or away from each other or as concentrically disposed cylinder elements which are mutually displaceable along a common axis.

14. The locking device according to claim 1, wherein
the piston unit (2) has a throughflow opening (D).

15. A locking device having
a locking unit with a piston unit (2) and
a control unit with a switch element (7) which is moveable relative to the piston unit and with a locking system (3) with which the piston unit can be locked,
a throughflow opening (S) which is configured at least partially by the piston unit, by the switch element or by the piston unit and the switch element, and
a magnetorheological and/or electrorheological material (M) which is disposed at least partially in the throughflow opening (S), and
a field producer (4), with which a magnetic and/or electrical field can be produced in at least one partial region of the throughflow opening (S),
the magnetorheological and/or electrorheological material being able to be moved at least partially through the throughflow opening (S), when the field is switched off, by the relative movement of piston unit and switch element, and the locking system being able to be subjected to a pressure, when the field is switched on, by the relative movement of piston unit and switch element, and the locking state of locking system and piston unit being able consequently to be changed,
wherein
the piston unit (2) has a throughflow opening (D), the throughflow opening (S) and the throughflow opening (D) being configured and disposed such that the locking state of locking system and piston unit can be changed when the field is switched on and the through-movement of the material through the throughflow opening (S) is restricted or prevented by the field, the pressure impingement is consequently produced and the throughflow opening (D) of the piston unit is opened or closed by the produced pressure by means of the locking system.

16. The locking device according to claim 15, wherein
the switch element is disposed at least partially within the piston unit.

17. The locking device according to claim 16, having
a cavity (H) which is configured within the piston unit and is subdivided by the switch element and the throughflow opening (S) into two chambers (H1, H2) which are connected by the throughflow opening (S) and between which the magnetorheological and/or electrorheological material can be moved to and fro.

18. The locking device according to claim 1, wherein
the locking unit comprises a non-field-controllable fluid (F).

19. The locking device according to claim 18, wherein
the non-field-controllable fluid comprises at least partially the same fluid which serves as carrier fluid of the magnetorheological and/or electrorheological material.

20. The locking device according to claim 18, having
characterised in that
two chambers (K1, K2) which are connected are configured in the housing, between which chambers the non-field-controllable fluid can be displaced by means of a relative movement of piston unit and housing.

21. The locking device according to claim 15, having
a housing (1).

22. The locking device according to claim 15, wherein
the housing is part of the locking unit
and/or the piston unit, the switch element, the locking system and/or the material is disposed at least partially within the housing.

23. The locking device according to claim 15, wherein
the switch element is a switch rod.

24. The locking device according to claim 1, wherein
the locking device is in the locked state without a produced field
or
the locking device is in the unlocked state without a produced field.

25. The locking device according to claim 1, having
the configuration as a hydraulic lock, the locking system and the piston unit being moveable relative to each other, the locking system closing the piston unit in the locked state and the piston unit not being closed by the locking system in the unlocked state
or having
the configuration as a mechanical lock, the locking system locking the piston unit in its moveability in the locked state and the piston unit not being locked in its moveability by the locking system in the unlocked state.

26. The locking device according to claim 25, having
a mechanical lock in which, in the unlocked state, the piston unit is moveable relative to the housing and/or relative to the locking system and in which, in the locked state, the piston unit is not moveable relative to the housing and/or relative to the locking system.

27. The locking device according to claim 1, wherein
the locking system is configured as part of the control unit
or
the locking system is configured as part of the locking unit.

28. The locking device according to claim 1, wherein
the locking system is disposed at least partially within the piston unit
and/or is surrounded at least partially by the piston unit.

29. The locking device according to claim 1, wherein
the piston unit is moveable relative to the housing.

30. The locking device according to claim 1, wherein
the locking unit and/or the control unit has a spring element (6).

31. The locking device according to claim 30, having
a spring element which is configured as spring connection between piston unit and locking system (closing spring) and/or as spring connection between different elements of the control unit (restoring spring) and/or the locking system is constructed from a plurality of partial elements which are moveable relative to each other and at least two of these partial elements are connected by the spring element.

32. The locking device according to claim 1, having
a field producer in the form of at least one magnet and a magnetic circuit which is configured by this in the locking device and encompasses the intermediate space (Z) or the throughflow opening (S).

33. The locking device according to claim 32, having
at least one electromagnet and at least one permanent magnet in the magnetic circuit.

34. The locking device according to claim 1, having
a field producer in the form of at least one pair of electrodes together with at least one voltage source, the surfaces or parts of the control elements which are moveable relative to each other being configured as electrodes.

35. The locking device according to claim 1, wherein
the field producer is connected securely to the control unit, the switch element and/or the piston unit.

36. The locking device according to claim 1, wherein
the magnetorheological material comprises a magnetorheological fluid, a magnetorheological gel, a magnetorheological elastomer and/or a magnetorheological foam and/or in that the electrorheological material comprises an electrorheological fluid, an electrorheological gel, an electrorheological elastomer and/or an electrorheological foam.

37. The locking device according to claim 1, having
the locking of a translatory movement or the locking of a rotary movement.

38. The locking device of claim 1, which is adapted for closing a door, a window or a shutter.

39. An operating element containing a locking device according to claim 1.

40. A magnetorheological and/or electrorheological locking method in which a piston unit is locked and/or unlocked comprising producing a magnetic and/or an electrical field in an intermediate space (Z) which is filled at least partially with a magnetorheological and/or electrorheological material or in a throughflow opening (S) which is filled at least partially with this material,
wherein the method utilizes
a locking device according claim 1.

41. (canceled)

42. A magnetorheological and/or electrorheological locking method in which a piston unit is locked and/or unlocked comprising producing a magnetic and/or an electrical field in an intermediate space (Z) which is filled at least partially with a magnetorheological and/or electrorheological material or in a throughflow opening (S) which is filled at least partially with this material,
wherein the method utilizes a locking device according claim 1.
